(19) United States
(12) Patent Application Publication
(10) Pub. No.: US 2024/0426071 A1
(43) Pub. Date: Dec. 26, 2024

(54) APPARATUS FOR INSTALLING PILES

(71) Applicant: SPINEX SYSTEMS, INC., Aiken, SC (US)

(72) Inventors: Kym Anthony Plotkin, Ormeau (AU); Cameron Gaylard, Burleigh Heads (AU)

(73) Assignee: SPINEX SYSTEMS, INC., Aiken, SC (US)

(21) Appl. No.: 18/700,874

(22) PCT Filed: Oct. 14, 2022
(86) PCT No.: PCT/AU2022/051235

§ 371 Date: Apr. 12, 2024

Related U.S. Application Data
(60) Provisional application No. 63/256,176, filed on Oct. 15, 2021.

(51) Int. Cl. E02D 7/22

(52) U.S. Cl. CPC E02D 7/22

(57) ABSTRACT

An apparatus for installing two spaced piles into the ground enables rapid and precise positioning of the piles. The apparatus comprises: a first projection for inserting into a first pile, a second projection for inserting into a second pile, a first pile drive associated with the first projection, and a second pile drive associated with the second projection, wherein the first projection is movable along a first path, the second projection is movable along a second path, and the first pile drive and the second pile drive are movable between a first orientation in which the first and second projections extend generally vertically and a second orientation in which the first and second projections extend generally horizontally.

### TECHNICAL FIELD

The present invention relates to an apparatus for installing piles, such as screw piles and blade piles.

### BACKGROUND ART

Many large-scale solar farms utilise solar trackers so that the photovoltaic solar panels move during the day to remain more closely aligned with the position of the sun. This increases electricity production from the solar panels.

Solar trackers in large-scale solar farms typically comprise an array of solar panels or a series of solar panels mounted to a long torque tube or a series of torque tubes that are in alignment with each other. A drive motor rotates the torque tube(s), which, of course, causes the solar panels to rotate with the torque tube to closely follow the sun as the sun moves across the sky during the day. The torque tube is normally supported on or suspended from a number of spaced support members and it is necessary to accurately position the support members in order to ensure that the torque tube is in alignment and that rotation of the torque tube can occur.

There are a variety of piles that have been utilized for the support of solar trackers, particularly single axis solar trackers. In some instances, I or H-beams are employed, and these beams are driven into the ground to a desired depth. An example of such a beam can be seen in FIG. 1. After installation of the beams in the earth, a bearing assembly is connected thereto with a variety of bolts. The beam and the bearing typically include some means of adjusting the bearing relative to the beam to allow misalignments to be corrected.

In other instances, screw piles have been devised that with the use of special screw machinery can be screwed into the earth to a desired depth. These screw piles typically employ a helical screw thread that wraps around a portion of the center post of the pile.

While both traditional I or H-beam piles and screw piles are generally useful, they do create challenges for the industry. For I or H-beam piles there is quite a bit of effort and labor expended on proper installation and then subsequent mounting and alignment of the bearings. For screw piles alignment can also be a challenge, particularly where two or more screw piles are employed to support a single bearing. Each of these must be aligned with each other, and then with the remaining piles of the solar tracker. Moreover, the bearing still needs to be fitted and aligned with other bearings in the solar tracker.

One of the present inventors devised a support system and structure for supporting solar trackers and intended for use in a solar farm that was being developed in Moree in the Australian state of New South Wales in 2014. FIG. 1 shows a schematic view of this proposal. The solar tracker system shown in FIG. 1 has a torque tube 10 passing through and supported by bearings 11. A plurality of spaced supports are provided to support the bearings 11 and, in turn, the torque tube 10. A central support 12 comprises four screw piles or blade piles 13, 14, 15, 16. The central support 12 supports the motor that drives the torque tube. The blade piles are available from Blade Pile Pty Ltd and may be as described in Australian innovation patent number 2011100820. The screw piles or blade piles 13, 14, 15, 16 are inserted or drilled into the ground at an angle to vertical. A top plate 17 is mounted to the top of each of the screw piles 13, 14, 15, 16. The top plate 17 acts to tie the tops of the screw piles 13, 14, 15, 16 together and also provides a mounting surface for an upright 18 that carries a motor 19.

A number of other supports are also provided to support the torque tube. These other supports are spaced from each other and are essentially identical. The other supports, one of which is shown as a support structure 20, includes a first blade pile 21 screwed into the ground at an angle to vertical and a second blade pile 22 screwed into the ground at an angle to vertical. The tops of the blade piles 21, 22 are spaced very close to each other or even in abutment with each other. A top gusset plate 23 is connected to the tops of the blade piles 21, 22. An upright 24 holds the bearing 11 which, in turn, receives the beam 10. Thus, support structure 20 forms an A-frame structure that resists bending in a direction transverse to the longitudinal axis of the beam 10, which is very desirable in solar trackers, as wind forces on the solar panels tend to produce strong forces transverse to the longitudinal axis of the tracker.

Other solar farm installers have also suggested that a solar tracker support system can be constructed from pairs of piles installed into the ground, either parallel to each other or at an angle to each other.

It will be clearly understood that, if a prior art publication is referred to herein, this reference does not constitute an admission that the publication forms part of the common general knowledge in the art in Australia or in any other country.

SUMMARY OF INVENTION

The present invention is directed to an apparatus for installing a pair of piles in an efficient manner.

In a first aspect, the present invention provides an apparatus for installing two spaced piles into the ground, the apparatus comprising a first projection for inserting into a first pile, a second projection for inserting into a second pile, a first pile drive associated with the first projection, and a second pile drive associated with the second projection, wherein the first projection is movable along a first path, the second projection is movable along a second path, and the first pile drive and the second pile drive are movable between a first orientation in which the first and second projections extend generally vertically and a second orientation in which the first and second projections extend generally horizontally.

In one embodiment, the apparatus includes a first grabber associated with the first projection and a second grabber associated with the second projection, the first grabber operative to hold a first pile in position relative to the first projection, the second grabber operative to hold a second pile in position relative to the second projection.

In one embodiment, the first grabber comprises opposed jaws movable between an open position in which the jaws are spaced far apart from each other and a closed position in which the jaws contact a pile located on the first projection. The second grabber may be similarly arranged.

In one embodiment, the apparatus includes a first pile guide associated with the first projection and a second pile guide associated with the second projection. In one embodiment, the first pile can slide through first pile guide as the first pile is being installed into the ground and the second pile can slide through the second pile guide as the second pile is being installed to the ground.

In one embodiment, the first pile drive moves reciprocally along a straight first path. The second pile drive may also move reciprocally along a straight second path.

In one embodiment, the first pile drive is mounted for reciprocal movement along a first mast and the second pile drive is mounted for reciprocal movement along a second mast, the first projection moving reciprocally with the first pile drive and the second projection moving reciprocally with the second pile drive.

In one embodiment, the first mast is mounted to a frame or a body and the second mast is mounted to a frame or a body. The frame or body to which the second mast is mounted may comprise the same frame or body to which the first mast is mounted, or the frame or body to which the second mast is mounted may comprise a separate frame or body to which the first mast is mounted.

In one embodiment, the first projection can move laterally relative to the frame or body and the second projection can move laterally relative to the frame or body. In one embodiment, the first pile drive and first projection can move laterally relative to the frame or body and the second pile drive and second projection can move laterally relative to the frame or body. In one embodiment, the first pile drive and first projection are mounted to a first intermediate frame body and the second drive and second projection are mounted to a second intermediate frame or body, and the first intermediate frame or body and the second intermediate frame or body can move laterally relative to the frame or body.

In one embodiment, the frame or body is mounted to a further frame or body, with the frame or body being rotatable relative to the further frame or body.

In one embodiment, the first projection and the second projection are rotatable about a horizontally-extending axis of rotation. In this manner, the first projection and the second projection can move between a horizontal orientation and vertical orientation. In some embodiments, the first projection and the second projection are rotatable from the vertical orientation to the horizontal orientation and can rotate further past the horizontal orientation.

In one embodiment, the first mast is provided with a first track along which the first pile drive can move and the second mast is provided with a second track along which the second pile drive can move. In one embodiment, the first track comprises a first track member mounted to the first mast and the second track comprises a second track member being mounted to the second mast. In one embodiment, the first track on the first mast may comprise a continuous chain, a continuous belt, a worm gear drive, an extendable and retractable arm or cylinder, a rack and pinion drive, a funicular track and cogged wheel drive, a monorail and monorail wheel drive, or indeed any arrangement that allows the first pile drive and the second pile drive to reciprocally move along the first track and the second track.

In one embodiment, the first pile drive is mounted to a first carriage, the first carriage being movable along the first mast and the second pile drive is mounted to a second carriage, the second carriage being movable along the second mast.

In one embodiment, the frame or body is rotatable about a first horizontal axis and is rotatable about a second horizontal axis, the second horizontal axis being essentially orthogonal to the first horizontal axis.

In one embodiment, the body or frame may be rotatable about a vertical axis.

In one embodiment, the apparatus is adapted to be connected to an arm or a boom of an excavator or the like.

In one embodiment, the apparatus includes a mounting adapter for mounting to a boom or an arm of an excavator like, the body or frame being rotatable relative to the mounting adapter.

In one embodiment, the first pile drive is movable synchronously with the second pile drive. In another embodiment, the first pile drive can move independently of the second pile drive.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 2 shows a perspective view of an apparatus in accordance with an embodiment of the present invention;

FIGS. 3 to 8 show schematic views of the steps involved in installing a pair of piles vertically into the ground, using the apparatus as shown in FIG. 1;

FIGS. 9 to 12 show schematic views of the steps involved in installing a pair of piles into the ground, with the piles being at an angle to each other, using the apparatus as shown in FIG. 1; and

FIGS. 13 to 18 show schematic views of an apparatus in accordance with an embodiment of the present invention, to show the possible rotation of the apparatus.

FIG. 19 is a left front perspective view of an apparatus in accordance with an alternative embodiment of the present invention.

FIG. 20 is a right front perspective view of the apparatus of FIG. 19.

FIG. 21 is a top view of the apparatus of FIG. 19.

FIG. 22 is a front view of the apparatus of FIG. 19.

FIG. 23 is a right-side view of the apparatus of FIG. 19.

FIG. 24 is a close-up view of a control console of the apparatus of FIG. 19.

FIG. 25 shows a close-up view of an alternative embodiment of a pile design and drive tool suitable for use in the present invention.

FIG. 26 shows a perspective view of a through-ring welded into the pile shown in FIG. 25.

### DETAILED DESCRIPTION OF THE DRAWINGS

The skilled person will understand that the drawings have been provided for the purposes of describing preferred embodiments of the present invention. Therefore, it will be understood that the present invention should not be considered to be limited to the features as shown in the attached drawings.

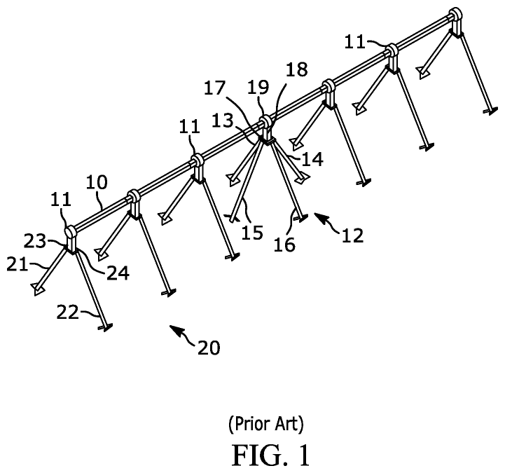

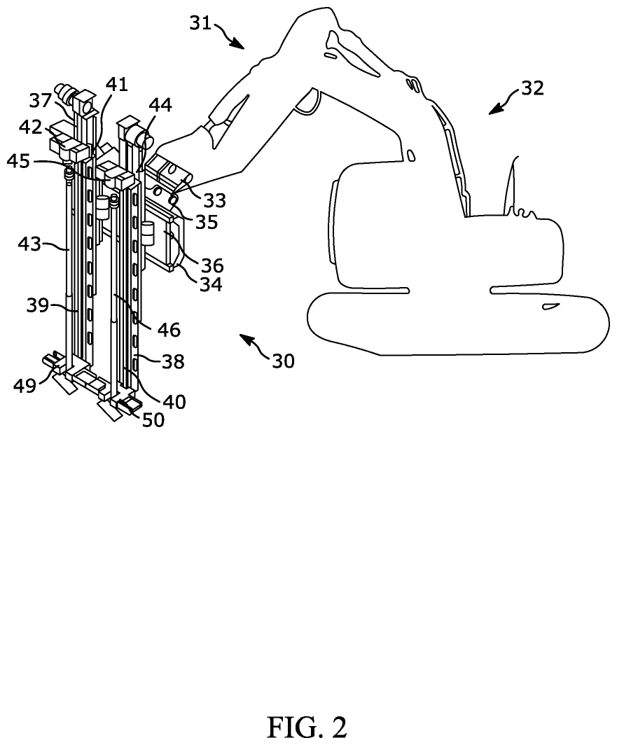

FIG. 2 shows an apparatus 30 for installing piles into the ground. The apparatus 30 can be connected to the boom or arm 31 of an excavator 32. In this manner, the company installing the piles can, if desired, hire an excavator from a local contractor and mount the apparatus 30 thereto. This does provide for greater flexibility than if the apparatus 30 formed part of a dedicated machine. However, it will also be understood that the apparatus 30 may form part of a dedicated machine.

The apparatus 30 comprises a quick hitch connector 33 that can quickly connect to the end of the boom 31 of the excavator 32. The quick hitch connector 33 may have a conventional quick hitch arrangement that need not be described further. A frame or body 34 is rotatably connected to the quick hitch connector 33 via a further frame or body 35. The further frame or body 35 may, for example, include a plate mounted to a rotating bearing that, in turn, is mounted to the further frame of body 35. The plate may provide a mount for mounting the frame or body 34 to the plate. In this manner, the frame or body 34 can rotate relative to the further frame or body 35. In one embodiment, the frame or body 34 can rotate about a horizontal axis.

The frame or body 34 may have a front plate 36 mounted to the frame or body 34. The front plate 36 may be mounted such that it can move laterally relative to the frame or body 34. An appropriate drive (not shown) can control the movement of the front plate 36 laterally relative to the frame or body 34. The skilled person will appreciate that a number of different arrangements may be used to mount the front plate 36 to the frame or body 34 to allow the front plate 36 to move laterally relative to the frame or body 34.

The front plate 36 has a first mast 37 mounted to it. The front plate 36 also has a second mast 38 mounted to it. The first mast 37 and the second mast 38 may be bolted or otherwise fixedly connected to the front plate 36. The first mast 37 has a first track 39 affixed thereto. The second mast 38 has a second track 40 affixed thereto.

In another embodiment, the front plate 36 comprises a first front plate 36A and a second front plate 36B, with the first front plate 36A being laterally movable independently of the second front plate 36B. In this manner, the lateral spacing between the first mast 37 and the second mast 38 can be varied by moving the first front plate 36A laterally relative to the second front plate 36B and vice versa.

A first carriage 41 is mounted for reciprocal movement to the first track 39. The first carriage 41 carries a first pile drive 42. The first pile drive 42 may comprise a pile drive motor, optionally with a hammer drive facility. The first pile drive 42 has a first projection 43, in the form of an elongated shaft mounted thereto and extending therefrom. The first pile drive 42 may be operated to cause the first shaft 43 to rotate. Although not shown in FIG. 2, the first shaft 43 has a drive engagement at its lower end to engage with a drive hub in a screw pile or a blade pile. Similarly, a second carriage 44 is mounted for reciprocal movement relative to the second track 40. The second carriage 44 carries a second pile drive 45. The second pile drive 45 may comprise a pile drive motor, optionally with a hammer drive facility. The second pile drive 45 has a second projection 46, in the form of an elongated shaft mounted thereto and extending therefrom. The second pile drive 45 may be operated to cause the second shaft 46 to rotate. Although not shown in FIG. 2, the second shaft 46 has a drive engagement at its lower end to engage with the drive hub in a screw pile or a blade pile.

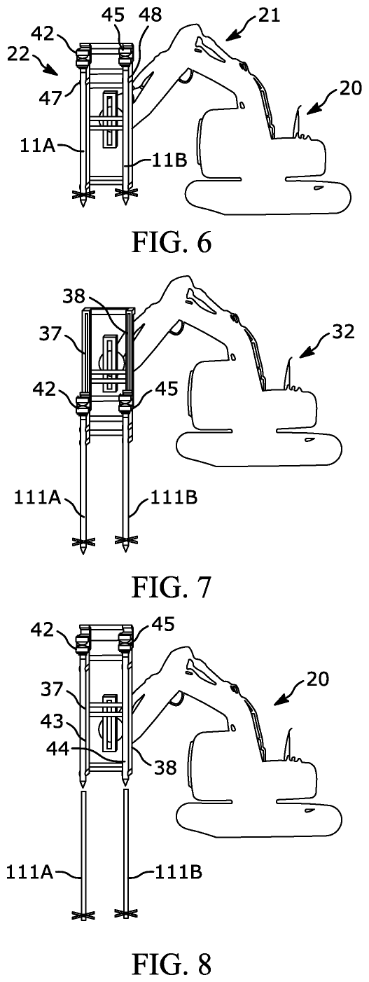

The apparatus 30 also includes a first grabber 47 and a second grabber 48 mounted just below the respective first pile drive 42 and the second pile drive 45. The grabbers 47, 48 are not shown in FIG. 2 but they can be seen in FIG. 6. Each grabber 47, 48 may comprise a pair of opposed jaws that can be opened and closed by use of an appropriate drive motor, or by use of appropriate hydraulic cylinders or pneumatic cylinders. Operation of the grabbers 47, 48 will be described in more detail hereunder.

The apparatus 30 further includes a first pile guide 49 and a second pile guide 50. The first pile guide 49 is located at the lower end of first mast 37 and the second pile guide 50 is located at a lower end of the second mast 38. Each pile guide 49, 50, may comprise movable opposed jaws that can be opened and closed. Appropriate drive means that will be known to the person skilled in the art may be used to open and close the jaws of the first pile guide 49 and the second pile guide 50. When closed, the jaws assist in guiding and stabilising insertion of a pile into the ground. The jaws may include a region made of a lubricious material, such as nylon or polytetrafluoroethylene, so that the shaft of a screw pile or a blade pile can smoothly move therethrough during installation of the screw pile or blade pile into the ground.

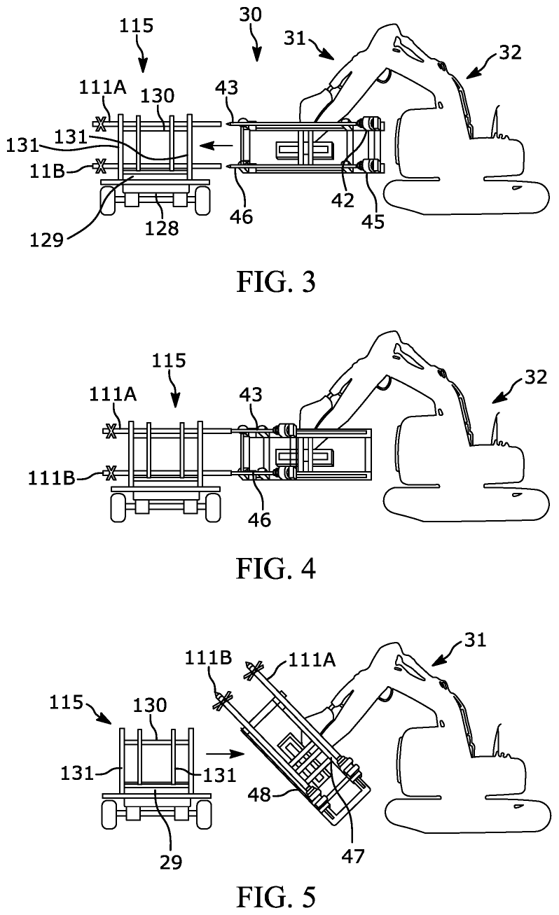

FIGS. 3 to 8 show schematic diagrams of the piling installation apparatus 30 installing a pair of piles into the ground in a vertical orientation. The piling installation apparatus 30 is a twin mast pile installation apparatus that is fitted to the end of the boom arm 31.

FIG. 3 shows a cradle 115 carrying first piles 111A and second piles 111B. The first piles 111A are located at a fixed height above the second piles 111B by the construction and arrangement of the cradle 115. The vertical height between piles 111A and 111B is essentially identical to the space between the first shaft 43 and the second shaft 46 when they are in the position shown in FIG. 3. The cradle 115 is positioned on a trailer 128 that is towed by a vehicle (not shown). The cradle 115 has a lower frame 129 for supporting the piles 111B, an upper frame 130 for supporting the piles 111A and a plurality of uprights 131 for holding the upper frame 130 in position above the lower frame 129. The cradle may be made from steel and welded together. The lower frame 129 carries one or more plates having a plurality of spaced recesses thereon, each individual recess receiving a pile. From the side, the one or more plates may look similar to a wine rack. Persons skilled in the art will appreciate that there will be a number of different arrangements in which each individual pile may be separately supported by the cradle. Each individual pile 111A is located vertically above an associated individual pile 11B.

In order to remove the piles 111A and 111B from the cradle 115, the twin mast pile installation apparatus 30 is oriented so that the first shaft 43 and the second shaft 46 are essentially horizontal or essentially parallel to the shafts of piles 111A and 111B, as shown in FIG. 3. The driveshaft 43 is aligned with the opening in the top of the shaft of one pile 111A and the driveshaft 46 is aligned with the opening in the top of the shaft of one pile 111B that is directly below the individual pile 111A. This is the orientation as shown in FIG. 3.

The twin mast pile installation apparatus 30 is then operated so that the first shaft 43 and the second shaft 46 are operated to extend into the shafts of the piles 111A, 111B. This is shown in FIG. 4. The twin mast pile installation apparatus 30 is then raised vertically by a small distance to lift the piles 111A, 111B off the cradle and the first and second shafts 43, 46 are then retracted horizontally and towards the excavator 32. This, of course, moves the piles 111A, 111B horizontally with the first and second shafts, as the piles 111A, 111B are now supported by the first and second shafts.

Once the ends of the piles 111A, 111B are clear of the cradle 115, the twin mast pile installation apparatus 30 is rotated upwardly, as shown in FIG. 5. If the piles 111A and 111B have not fully seated on the first and second shafts 43, 46, the piles 111A, 111B will slide down the driveshafts until they are fully seated. Grabbers 47, 48 on the twin mast pile installation apparatus 30 then grip the piles 111A, 111B and hold the piles in position relative to the first and second shafts 43, 46. The boom arm 31 of the excavator 32 is then moved and the installation apparatus 30 is rotated until the piles 111A, 111B are located vertically above the desired installation location for those piles. This is shown in FIG. 6. The drive motors of the first pile drive 42 and the second pile drive 45 are then operated to drive the piles 111A, 111B into the ground, as shown in FIG. 7. The grabbers may be released once the piles come into contact with the ground. As the piles 111A, 111B are driven into the ground, the drive motors of the first pile drive 42 and the second pile drive 45 move downwardly along the respective first mast 37 and second mast 38, as shown in FIG. 7. In the installation operation shown in FIG. 7, the drive motors of the first pile drive 42 and the second pile drive 45 may be operated simultaneously to simultaneously drive the piles 111A, 111B into the ground.

Once the piles 111A, 111B have been properly inserted into the ground, the first and second shafts 43, 46 are moved upwardly, as shown in FIG. 8, to remove the sirst and second shafts from the shafts of the installed piles 111A, 111B. The excavator 32 then moves along the to the next location at which the next pair of piles to be installed. The cradle 115 also moves along at the same time. The next pair of piles 111A, 111B are then removed from the cradle and installed into the ground by repeating the procedures shown in FIGS. 3 to 8.

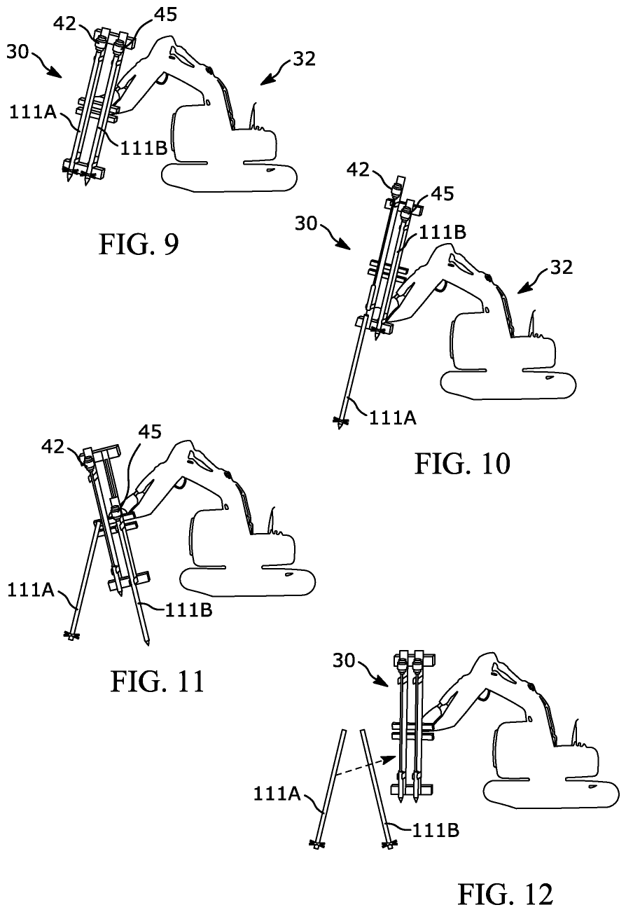

FIGS. 9 to 12 show use of the twin mast pile installation apparatus 30 to install the piles 111A, 111B into the ground at an angle to each other. The piles 111A, 111B are loaded onto their respective shafts 42, 24 of the twin mast installation apparatus 30 using the same procedure as described with reference to FIGS. 3, 4 and 5. However, in order to install pile 111A into the ground at a non-vertical angle, rather than moving the twin mast pile installation apparatus 30 to the vertical orientation as shown in FIG. 6, the twin mast pile installation apparatus 30 is moved to the angled orientation as shown in FIG. 9. In FIG. 9, the pile 111A is angled at the required angle for installation on the ground. Drive motor 42 is then operated to turn the first shaft 43 and the pile 111A and cause installation of the pile 111A downwardly at an angle. Second pile drive 45 is not operated at this time. This is shown in FIG. 10. Once the pile 111A has been inserted to the desired depth, the first shaft 43 is retracted from the shaft of the pile 111A. The twin mast pile installation apparatus 30 is then rotated to bring pile 111B to the desired angle for installation into the ground and the drive motor of the second pile drive 45 is operated to turn the second shaft 46 and the pile 111B, which causes installation of the pile 111B downwardly at the angle as shown in FIG. 11. The second shaft 46 may be moved laterally away from the first shaft 43 if additional clearance between the top of installed pile 111A and the second shaft 46 is required. Alternatively, both the first shaft 43 in the second shaft 46 may be moved laterally away from the installed first pile 111A if additional clearance is required.

Once the pile 111B has been fully inserted into the ground to the desired depth and at the desired angle, the second shaft 46 is retracted from the shaft of the pile 111B. FIG. 12 shows the installed piles 111A, 111B with the first and second shafts of the twin mast pile installation apparatus 30 being withdrawn from the shafts of the piles.

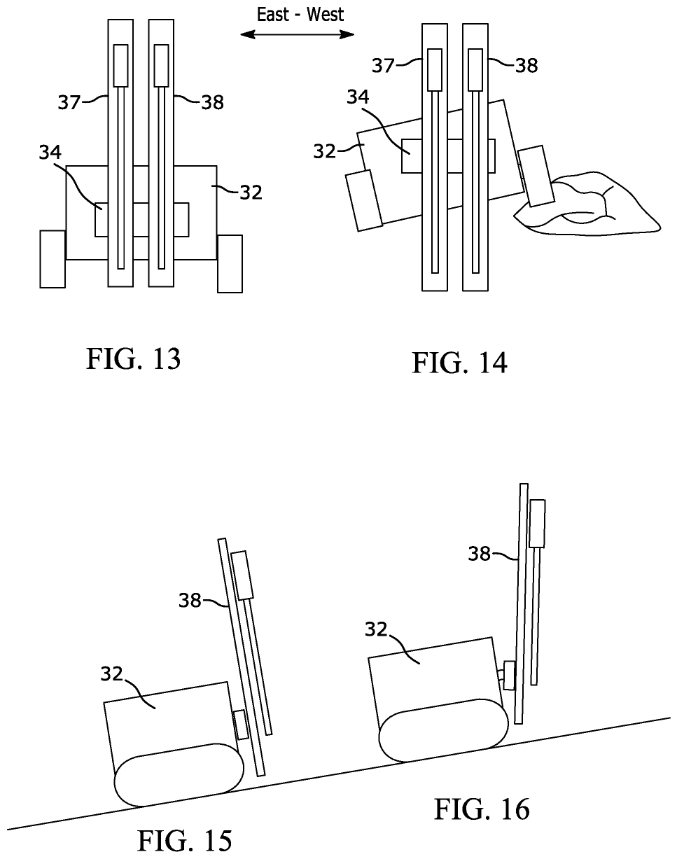

In one embodiment, the masts 37, 38 are rotatable about a first horizontal axis, and rotatable about a second horizontal axis that is orthogonal to the first horizontal axis, and also rotatable about a vertical axis. This enables the masts to be accurately positioned irrespective of the slope of the ground on which the excavator 32 is located. This is shown schematically in FIGS. 13 to 18.

FIGS. 13 shows a front schematic view of the excavator 32 sitting on level ground with the mast 37, 38 also being vertical. In FIG. 14, the excavator 32 is not on level ground but the masts 37, 38 have been rotated relative to the excavator 32 about a horizontal axis to ensure that the masts 37, 38 are vertically positioned. As can also be seen in FIGS. 13 and 14, the mast 37, 38 have been moved laterally relative to the frame or body 34 in order to ensure correct positioning of the masts relative to the desired location of the installed solar tracker.

FIGS. 15 and 16 show side schematic views of the excavator 32 facing uphill. In FIG. 15, the mast 38 is perpendicular to the ground level but it is not vertical. In order to ensure that the piles are inserted vertically into the ground, the mast 38 is rotated about a horizontal axis coming out of the page to the position shown in FIG. 16. The horizontal axis about which the mast rotates in FIGS. 15 and 16 is orthogonal to the horizontal axis about which the mast rotates in FIGS. 13 and 14.

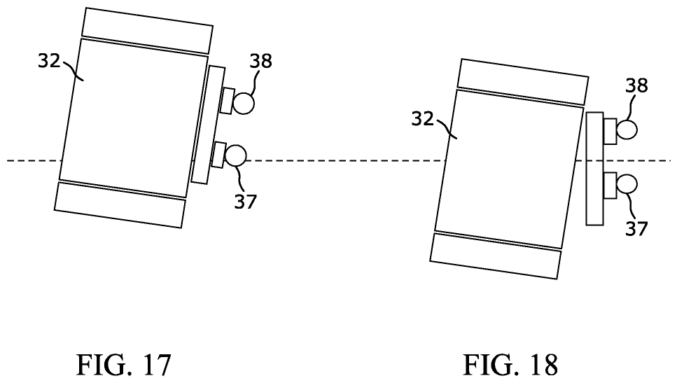

FIGS. 17 and 18 show plan views of the excavator 32 and the first and second mast 37, 38. In FIG. 17, the excavator 32 is out of alignment with the desired installation location of the piles. In FIG. 18, the mast 37, 38 have been rotated about a vertical axis to bring them into proper alignment.

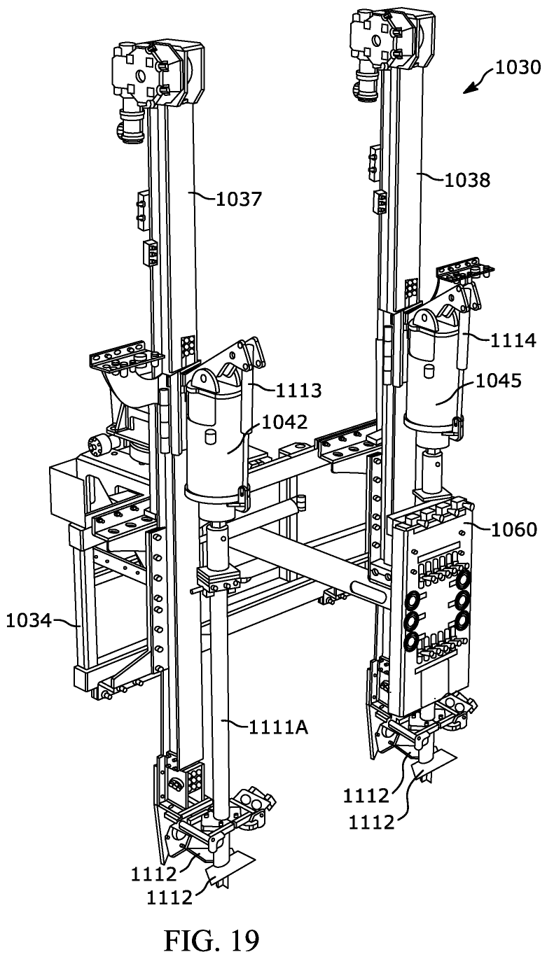

FIG. 19 is a left front perspective view of an apparatus 1030 in accordance with an alternative embodiment of the present invention. The functionality of the apparatus 1030 generally corresponds with the functionality of the apparatus 30 as described above. For example, a frame 1034 of the apparatus 1030 is designed to be removably attached to the end of a boom of an excavator (such as the excavator 32) or other equipment. A first mast 1037 and a second mast 1038 are then connected to the frame 1034 and support, respectively, a first pile drive 1042 and a second pile drive 1045, which are hydraulically powered augers.

The distal end of a drive shaft 1115, 1116 (or projection) extends from each of the first and second pile drives 1042, 1045, respectively, and into the hollow tubular frames of, respectively, piles 1111A, 1111B. Each drive shaft 1115, 1116 can drive the tubular frames or, alternatively, extend longitudinally through the tubular frames to directly drive ground-engaging blades 1112 welded to the distal ends of the piles 1111A, 1111B. Pile change cylinders 1113, 1114 enable rapid release and re-loading of piles 1111A, 1111B, respectively, following pile installation.

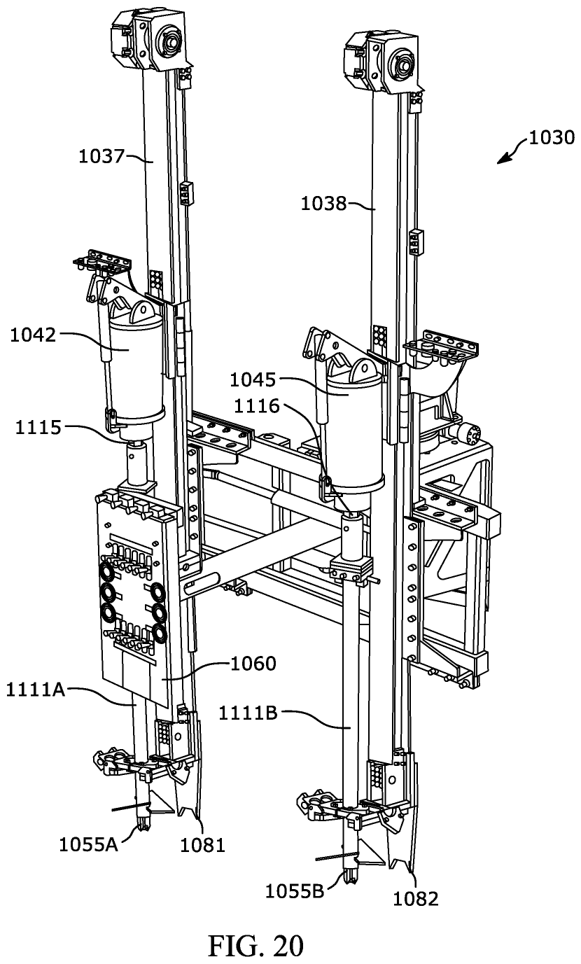

FIG. 20 is a right front perspective view of the apparatus of FIG. 19. As will be understood by a person skilled in the art, each pile drive 1042, 1045 is motorized and can be moved up and down the first and second mast 1037, 1038, respectively. A sharpened rock cutting tip 1055A, 1055B at the distal end of each drive shaft 1115, 1116, respectively, is shown extending out the end of each pile 1111A, 111B, respectively.

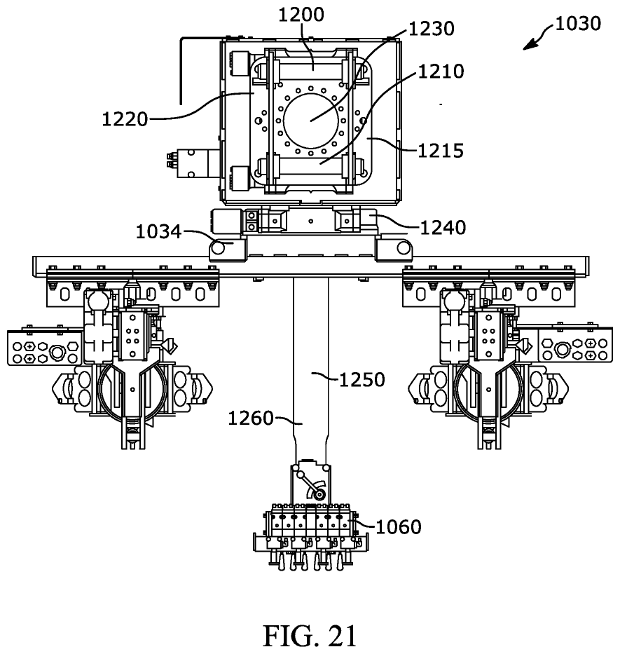

FIG. 21 is a top view of the apparatus of FIG. 19. As will be understood by those skilled in the art, the frame 1034 and both the first mast 1037 and the second mast 1038, and the sub-systems attached thereto, are rotatable relative to a mounting adapter 1215 that includes attachment pins 1200, 1210, which connect to an excavator boom. Dual rotator mechanisms include a vertical axis rotator 1220 that rotates about a vertical axis 1230 (which projects in and out of the page of FIG. 21), and a horizontal axis rotator 1240 that rotates about a horizontal axis 1250, which corresponds with a longitudinal axis of a support arm 1260 of a control console 1060.

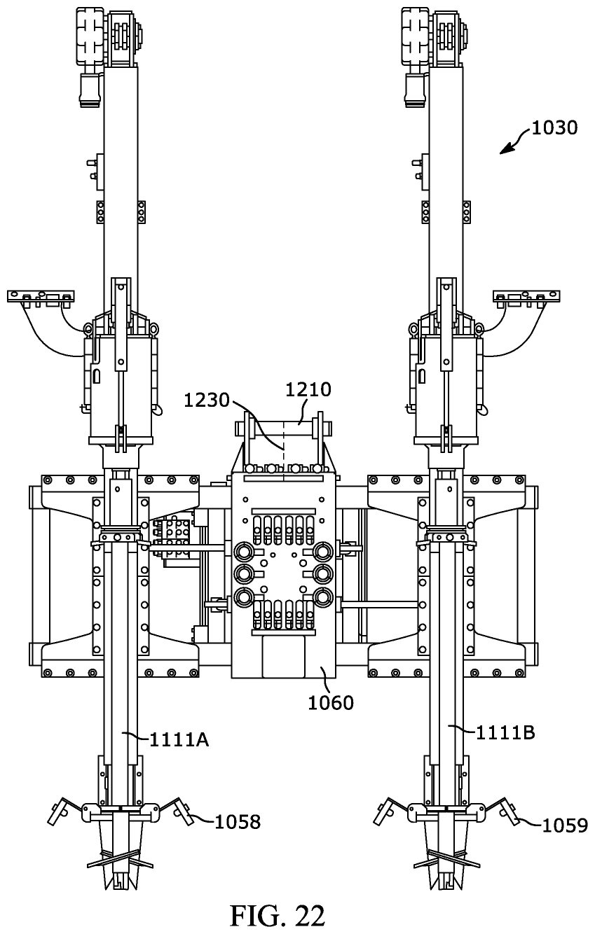

FIG. 22 is a front view of the apparatus of FIG. 19. Automatic centralizing devices 1058, 1059 enable each pile 1111A, 1111B, respectively, to be positioned and centered as each pile 1111A, 1111B is rotated into the ground. The centralizing devices 1058, 1059 (shown in an open and non-engaged position) also enable easy re-loading of the apparatus 1030 with piles 1111A, 1111B.

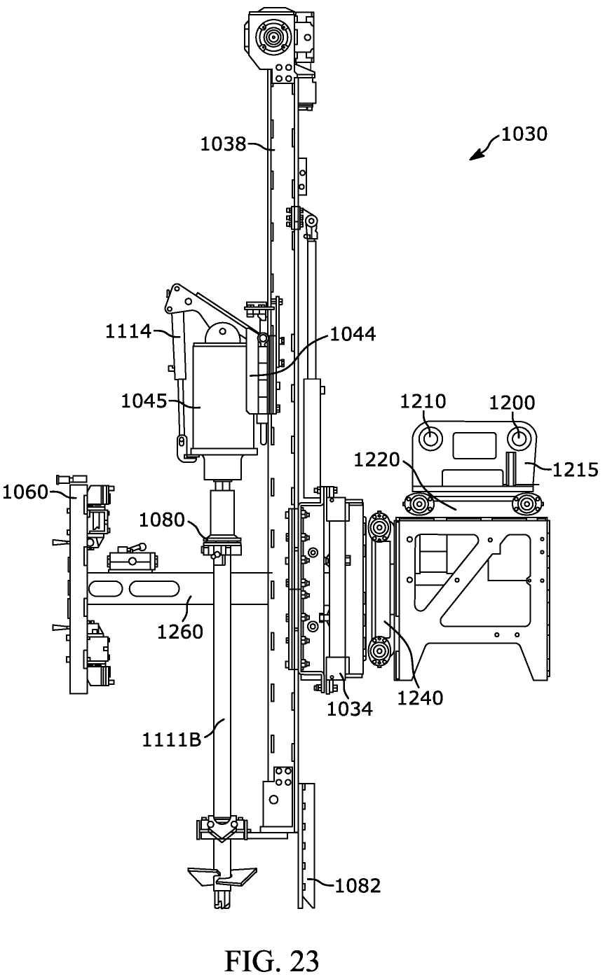

FIG. 23 is a right-side view of the apparatus of FIG. 19. A carriage 1044 is shown, which enables movement of the pile drive 1045 up and down the mast 1038.

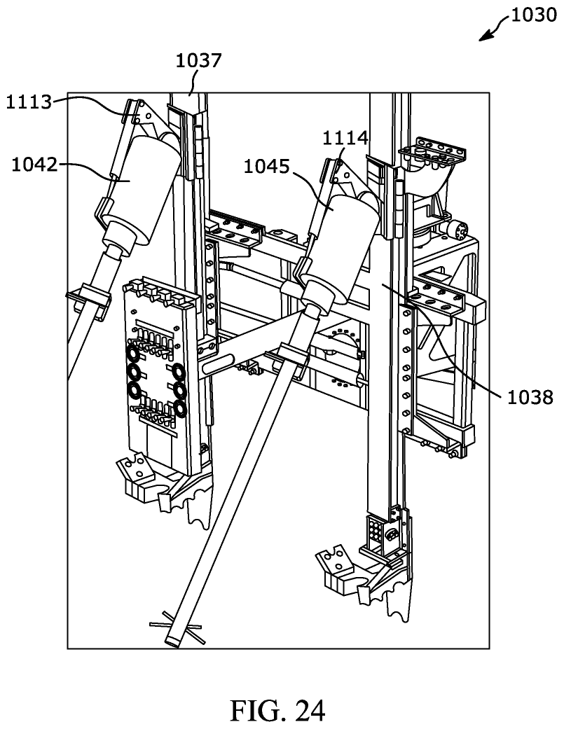

FIG. 24 is a close-up view of the control console 1060 of the apparatus of FIG. 19. The control console 1060 includes bi-directional levers for the following actions: Rotation left 1061, Feed left 1062, Feed extend left 1063, 360A Rotator (Front) 1064, Feed shift left 1065, Head tilt left 1066, Head tilt right 1070, Feed shift right 1071, 360B Rotator (Top) 1072, Feed extend right 1073, Feed right 1074, and Rotation right 1075. Further, the control console 1060 includes hydraulic pressure gages for the following: System bottom 1067, Rotation right 1068, Feed right 1069, Feed left 1076, Rotation left 1077 and System top 1078. Thus, after the mounting adapter 1215 is positioned by an excavator at a pile installation site, the control console 1060 can be used to fully control final positioning of the first and second pile drives 1042, 1045 and the ground engaging distal ends of the piles 1111A, 1111B and, finally, rotation and installation of the piles 1111A, 1111B into the ground.

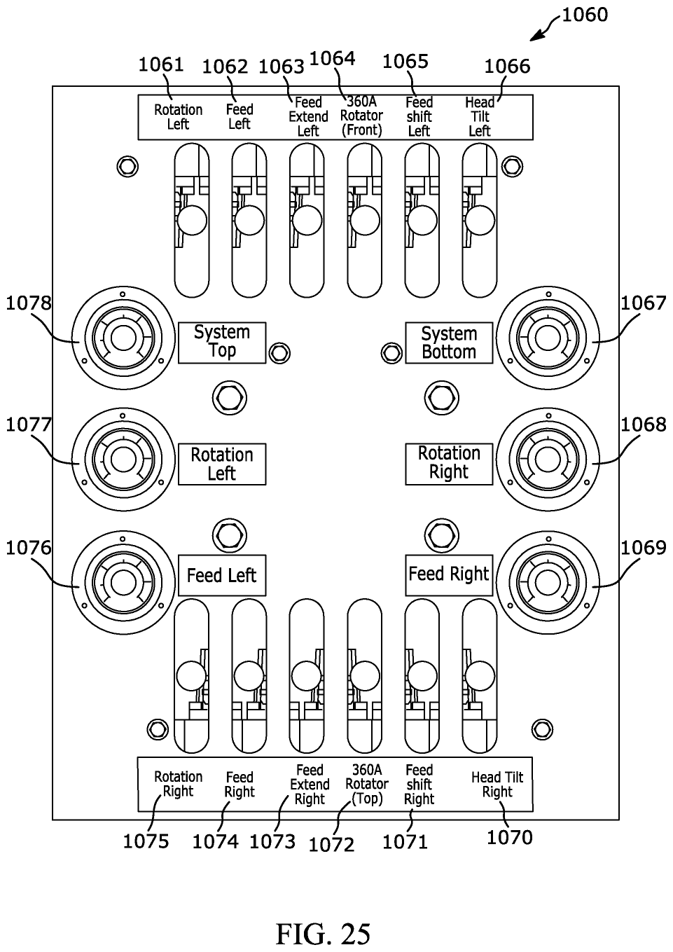

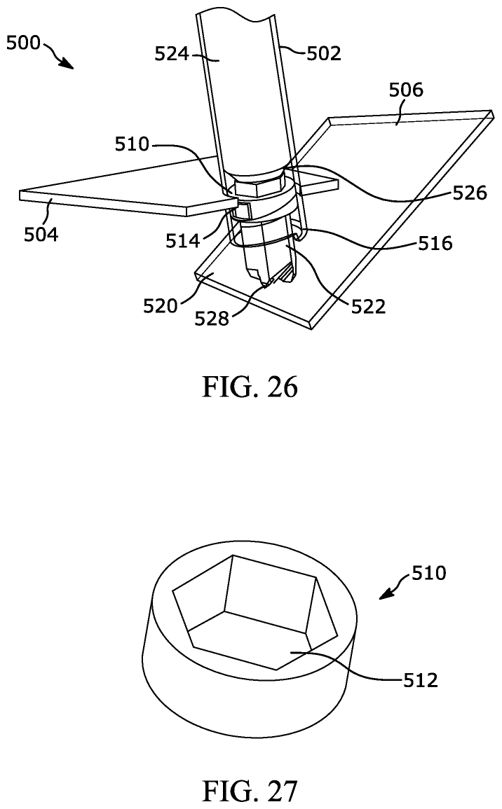

FIG. 25 shows a close-up view of an alternative embodiment of a pile design that is suitable for use in preferred embodiments of the present invention. The pile 500 has a shaft 502 having two blades 504, 506 affixed thereto, such as by welding. The blades are in the form of plates that are angled relative to each other as shown in FIG. 25. A through-ring 510 having a central opening 512 is positioned inside the shaft 502 at a location that is at, near or adjacent to the blades 504, 506. The opening 512 in the through-ring 510 has a hexagonal shape that can engage with a hexagonal drive tool. A perspective view of the through-ring 510 is shown in FIG. 26. The skilled person will appreciate that the opening 512 may have a number of other shapes that can engage with a complementary-shaped drive tool. The through-ring provides an open socket for engaging with the drive tool. The through-ring 510 is welded to the shaft to permanently affix the through-ring to the shaft. For example, a plurality of openings 514 may be cut or formed into the wall of the shaft and weld metal deposited between the openings and the outer diameter of the through-ring in order to weld the through-ring to the shaft of the pile. In the embodiment shown in FIG. 25, four such openings are provided. Shoulder 516 is formed at the lower end of shaft 502 of the pile 500 to sweep away soil and rocks dislodged by the action of screwing the pile 500 into the ground (a second such shoulder is formed diametrically opposite).

The drive tool 520 comprises a lower region 522 having a hexagonal outer shape. The lower region 522 is sized to fit through the opening 512 in the through-ring 510 and for the lower region 522 to engage with the inner surface of the through-ring 510 whereby rotation of the drive tool 520 causes rotation of the pile 500 to thereby drive the pile into the ground. The drive tool 520 has a shaft 524 (e.g., corresponding to the drive shaft 1115 or 1116 as described above) extending upwardly from the lower region 522 and the shaft 524 can be fitted with an engagement region at its upper end to enable the drive tool to engage with and be rotatably driven, such as by a motor or an auger drive. The drive tool 500 also has a shoulder 526 located above the lower region 522, with the shoulder 526 acting as a stop member to limit insertion of the drive tool into the pile 500. The lower end 528 of the drive tool 500 is formed as an attack bit to enable it to drill into the ground.

The pile installation apparatus in accordance with embodiments of the present invention allows a pair of piles to be quickly and efficiently installed into the ground. If the piles are to be installed parallel to each other in a vertical orientation, it is believed that installation of the pair of piles will take between three and four minutes. If the piles are to be installed into the ground at an angle to each other (and at an angle to vertical), it is believed that installation of the pair of piles will take between 3.5 and 4.5 minutes. This allows for very quick and efficient pile installation.

The apparatus of the present invention can be used to install conventional screw piles and blade piles. Blade piles may be supplied from Blade Pile Pty Ltd, of Burleigh heads, Queensland.

The drawings accompanying this specification show installation of a pair of piles. It will be appreciated that the present invention also encompass installation of single piles. In those instances, a single mast pile installation apparatus may be used.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. An apparatus for installing two spaced piles into the ground, the apparatus comprising:
a first projection for inserting into a first pile,
a second projection for inserting into a second pile,
a first pile drive associated with the first projection, and
a second pile drive associated with the second projection,
wherein the first projection is movable along a first path, the second projection is movable along a second path, and the first pile drive and the second pile drive are movable between a first orientation in which the first and second projections extend generally vertically and a second orientation in which the first and second projections extend generally horizontally.

2. The apparatus of claim 1, further comprising a first grabber associated with the first projection and a second grabber associated with the second projection, the first grabber operative to hold a first pile in position relative to the first projection, the second grabber operative to hold a second pile in position relative to the second projection.

3. The apparatus of claim 2, wherein the first grabber comprises opposed jaws movable between an open position in which the jaws are spaced far apart from each other and a closed position in which the jaws contact a pile located on the first projection.

4. The apparatus of claim 1, further comprising a first pile guide associated with the first projection and a second pile guide associated with the second projection.

5. The apparatus of claim 4, wherein the first pile is slidable through first pile guide as the first pile is being installed into the ground and the second pile is slidable through the second pile guide as the second pile is being installed to the ground.

6. The apparatus of claim 1, wherein the first pile drive is moveable reciprocally along a straight first path and the second pile drive is moveable reciprocally along a straight second path.

7. The apparatus of claim 1, wherein the first pile drive is mounted for reciprocal movement along a first mast and the second pile drive is mounted for reciprocal movement along a second mast, the first projection moveable reciprocally with the first pile drive and the second projection moveable reciprocally with the second pile drive.

8. The apparatus of claim 1, wherein the first mast is mounted to a frame or a body and the second mast is mounted to a frame or a body.

9. The apparatus of claim 1, wherein the first projection is moveable laterally relative to the frame or body and the second projection is moveable laterally relative to the frame or body. In one embodiment, the frame or body is mounted to a further frame or body, with the frame or body being rotatable relative to the further frame or body.

10. The apparatus of claim 1, wherein the first projection and the second projection are rotatable about a horizontally-extending axis of rotation, and whereby the first projection and the second projection are moveable between a horizontal orientation and a vertical orientation.

11. The apparatus of claim 1, wherein the first mast is provided with a first track along which the first pile drive is moveable and the second mast is provided with a second track along which the second pile drive is moveable.

12. The apparatus of claim 11, wherein the first track comprises a first track member mounted to the first mast and the second track comprises a second track member being mounted to the second mast.

13. The apparatus of claim 11, wherein the first track on the first mast comprises a continuous chain, a continuous belt, a worm gear drive, an extendable and retractable arm or cylinder, a rack and pinion drive, a funicular track and cogged wheel drive, or a monorail and monorail wheel drive.

14. The apparatus of claim 1, wherein the first pile drive is mounted to a first carriage, the first carriage being movable along the first mast and the second pile drive is mounted to a second carriage, the second carriage being movable along the second mast.

15. The apparatus of claim 1, wherein the frame or body is rotatable about a first horizontal axis and is rotatable about a second horizontal axis, the second horizontal axis being essentially orthogonal to the first horizontal axis.

16. The apparatus of claim 1, wherein the body or frame may be rotatable about a vertical axis.

17. The apparatus of claim 1, wherein the apparatus is adapted to be connected to an arm or a boom of an excavator or the like.

18. The apparatus of claim 1, wherein the apparatus includes a mounting adapter for mounting to a boom or an arm of an excavator like, the body or frame being rotatable relative to the mounting adapter.

19. The apparatus of claim 1, wherein the first pile drive is movable synchronously with, or independently of, the second pile drive.
